(19) United States
(12) Patent Application Publication
(10) Pub. No.: US 2014/0101523 A1
(43) Pub. Date: Apr. 10, 2014

(54) DISPLAY SYSTEM WITH CONTENT PRESENTATION MECHANISM AND METHOD OF OPERATION THEREOF

(71) Applicant: Samsung Electronics Co., Ltd., Gyeonggi-Do (KR)

(72) Inventors: Guy Bar-Nahum, San Francisco, CA (US); Daniel William Simmons, San Francisco, CA (US); Brenno Cantelli, Cupertino, CA (US); Kwame Ferreira, London (GB); Wei-Meng Chee, Sunnyvale, CA (US)

(73) Assignee: Samsung Electronics Co., Ltd., Gyeonggi-Do (KR)

(21) Appl. No.: 14/044,578

(22) Filed: Oct. 2, 2013

Related U.S. Application Data
(60) Provisional application No. 61/709,927, filed on Oct. 4, 2012.

(51) Int. Cl. G06F 17/21

(52) U.S. Cl. CPC G06F 17/21
USPC 715/201

(57) ABSTRACT

A method of operation of a display system includes: providing a format; displaying content with the format configured to display on a display interface; receiving input based on the content displayed with the format on the display interface; and receiving input based on the content displayed with the format on the display interface.

### CROSS-REFERENCE TO RELATED APPLICATION(S)

This application claims the benefit of U.S. Provisional Patent Application Ser. No. 61/709,927 filed Oct. 4, 2012, and the subject matter thereof is incorporated herein by reference thereto.

### TECHNICAL FIELD

An embodiment of the present invention relates generally to a display system, and more particularly to a system for content.

### BACKGROUND

Modern consumer and industrial electronics, especially devices such as graphical display systems, televisions, projectors, cellular phones, portable digital assistants, and combination devices, are providing increasing levels of functionality to support modern life including display and access to services. Research and development in the existing technologies can take a myriad of different directions.

In recent years content delivery or distribution over the Internet has become popular. Due to the advances in efficient file formats, the size of media files have become small enough to make their download via the Internet practical. Also, technological advances have led to higher-speed Internet connections and lower cost of memory. The combination of these advances make downloading media files, such as for images, documents, music, and videos, manageable and not too time consuming.

Electronic publishing and distribution embraces many different commercially available computer programs. Software has been developed that is specifically designed to electronically publish and distribute digital publications using the Internet. This software was designed to process documents in the format of conventional print publications.

Conventional systems for publishing or viewing digital publications have several problems, including those relating to standardization, formatting, and ease of use. Presently, there is no standard platform for publishers to electronically present their publications to subscribers. Some digital publications may be viewed using commonly available browsers, while other digital publications require the use of proprietary reader programs, which must be installed by subscribers on their devices in order for proprietary file extensions of those digital publications to be recognized or readable by those devices.

Multimedia content presentation on mobile devices includes simplistic interfaces derived from browser-based approaches to content display. Both flip-board type and flipping-book type applications only allow thumbing through unit content as a complete page. Attempting to duplicate the literal look and feel of a paper magazine, flip-board type and flipping-book type applications and their ilk, present static content.

Thus, a need still remains for a display system with content presentation. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a display system, including: a storage unit configured to provide access to a format; a display interface, coupled to the storage unit, configured to provide a display of content with the format; a communication unit, coupled to the display interface, configured to receive input based on the display; and a control unit, coupled to the communication unit, configured to update a second display of a second content with the format based on the input and configured to display on the display interface.

An embodiment of the present invention provides a method of operation of a display system including: providing a format; displaying content with the format configured to display on a display interface; receiving input based on the content displayed with the format on the display interface; and receiving input based on the content displayed with the format on the display interface.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a display system with image conversion mechanism in an embodiment of the present invention.

FIG. 2 is an example of a display interface of the first device.

FIG. 3 is an exemplary block diagram of the display system.

FIG. 4 is a control flow of the display system in an embodiment of the present invention.

FIG. 5 is an example of the display interface of the first device in an embodiment of the present invention.

FIG. 6 is an example of the display interface of the first device in an embodiment of the present invention.

FIG. 7 is an exemplary block diagram of a display system in an embodiment of the present invention.

FIG. 8 is a flow chart of a method of operation of a display system in an embodiment of the present invention.

### DETAILED DESCRIPTION

Structure and content of the format of the display interface can be created dynamically based on a request or other user interaction. The user interaction can be contextual and incorporate requests such as a search with the content search module or an input device click, as well as social, spatial, and temporal context such as a user with a guest near a point of interest, so the user receives the format of the display interface with content about that point of interest or other similar points of interest within the user's proximity.

Embodiments of the present invention can include a magazine module or a magazine application providing customized magazine structure or content of a magazine format learned from a user's behavior such as a system for presenting dynamic multimedia content in a magazine style layout. Content can be related to multimedia presentation and user discovery on computing devices including multimedia presentation on mobile devices. The present invention addresses problems of simplistic interfaces derived from browser-based approaches for content display such as not formatted like magazines, do not have active content, or are not created dynamically in response to topic or context.

The present invention includes embodiments using at least a paper magazine as a model for content presentation and user discovery of content under general and variable subject areas. Presentation integrates elements of all of layout, structured elements, and content into a style reflecting paper magazines in terms of complexity, with dynamic (active) browsing and navigation through its content. A magazine can also be considered a metaphor for rich content-driven software applications.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

One skilled in the art would appreciate that the format with which image information is expressed is not critical to some embodiments of the invention. For example, in some embodiments, image information is presented in the format of (X, Y); where X and Y are two coordinates that define the location of a pixel in an image.

In an alternative embodiment, three-dimensional image information is presented by a format of (X, Y, Z) with related information for color of the pixel. In a further embodiment of the present invention, the three-dimensional image information also includes an intensity or brightness element.

The term “image” referred to herein can include a two-dimensional image, three-dimensional image, video frame, a computer file representation, an image from a camera, a video frame, or a combination thereof. For example, the image can be a machine readable digital file, a physical photograph, a digital photograph, a motion picture frame, a video frame, an x-ray image, a scanned image, or a combination thereof.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

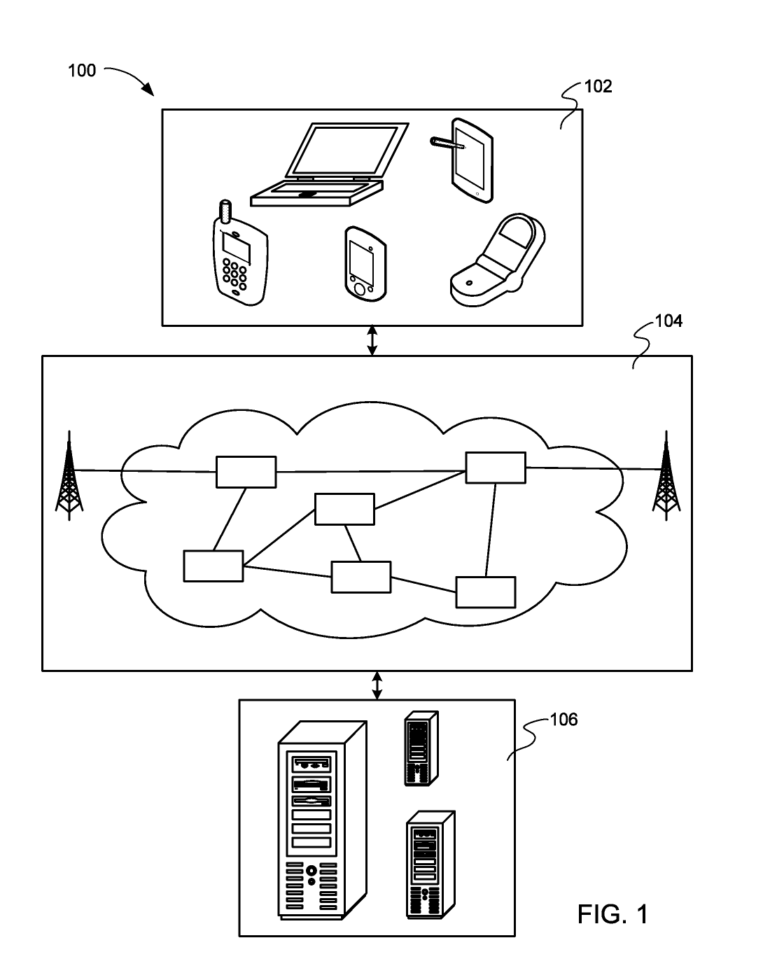

Referring now to FIG. 1, therein is shown a display system 100 with image conversion mechanism in an embodiment of the present invention. The display system 100 includes a first device 102, such as a client or a server, connected to a second device 106, such as a client or server. The first device 102 can communicate with the second device 106 with a communication path 104, such as a wireless or wired network.

For example, the first device 102 can be of any of a variety of display devices, such as a cellular phone, personal digital assistant, a notebook computer, a liquid crystal display (LCD) system, a light emitting diode (LED) system, or other multi-functional display or entertainment device. The first device 102 can couple, either directly or indirectly, to the communication path 104 to communicate with the second device 106 or can be a stand-alone device.

For illustrative purposes, the display system 100 is described with the first device 102 as a display device, although it is understood that the first device 102 can be different types of devices. For example, the first device 102 can also be a device for presenting images or a multi-media presentation. A multi-media presentation can be a presentation including sound, a sequence of streaming images or a video feed, or a combination thereof. As an example, the first device 102 can be a high definition television, a three dimensional television, a computer monitor, a personal digital assistant, a cellular phone, or a multi-media set.

The second device 106 can be any of a variety of centralized or decentralized computing devices, or video transmission devices. For example, the second device 106 can be a multimedia computer, a laptop computer, a desktop computer, a video game console, grid-computing resources, a virtualized computer resource, cloud computing resource, routers, switches, peer-to-peer distributed computing devices, a media playback device, a Digital Video Disk (DVD) player, a three-dimension enabled DVD player, a recording device, such as a camera or video camera, or a combination thereof. In another example, the second device 106 can be a signal receiver for receiving broadcast or live stream signals, such as a television receiver, a cable box, a satellite dish receiver, or a web enabled device.

The second device 106 can be centralized in a single room, distributed across different rooms, distributed across different geographical locations, embedded within a telecommunications network. The second device 106 can couple with the communication path 104 to communicate with the first device 102.

For illustrative purposes, the display system 100 is described with the second device 106 as a computing device, although it is understood that the second device 106 can be different types of devices. Also for illustrative purposes, the display system 100 is shown with the second device 106 and the first device 102 as end points of the communication path 104, although it is understood that the display system 100 can have a different partition between the first device 102, the second device 106, and the communication path 104. For example, the first device 102, the second device 106, or a combination thereof can also function as part of the communication path 104.

The communication path 104 can span and represent a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

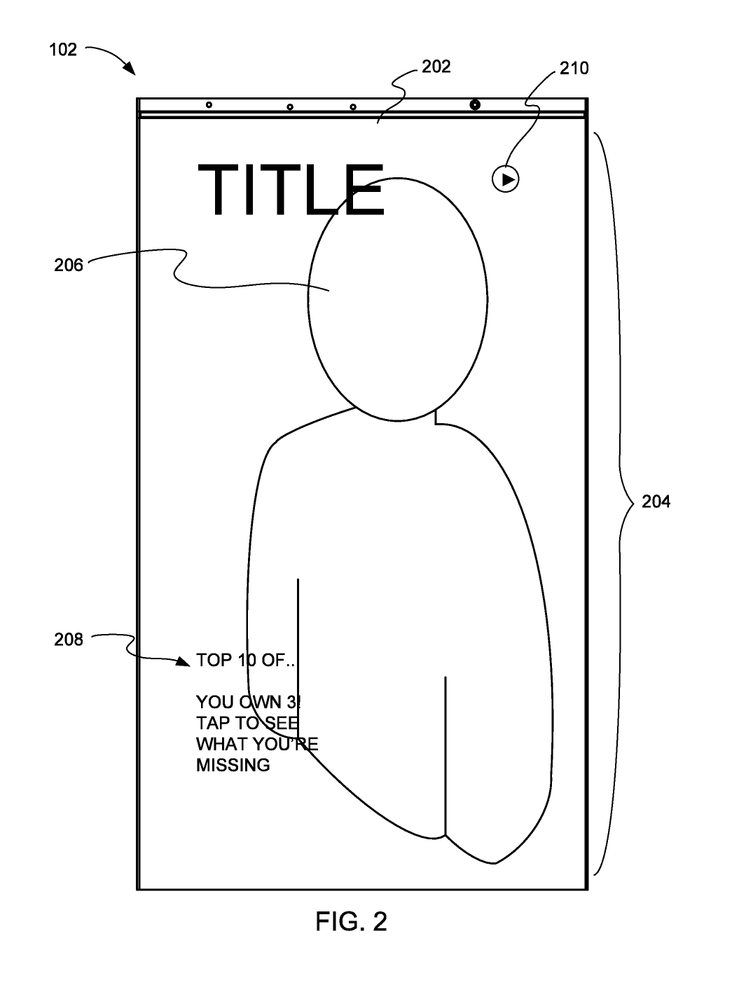

Referring now to FIG. 2, therein is shown an example of a display interface 202 of the first device 102. Similarly, the second device 106 of FIG. 1 can also include a display interface such as the display interface 202. The display interface 202 can display a format 204 such as a magazine format including an image 206, a text 208, a symbol 210, or combination thereof. The format 204 can include the text 208, associated with the image 206, overlapped or wrapped with the text 208.

The image 206, the text 208, or the symbol 210 can represent content specific to preferences, selections, viewing time, or combination thereof. The image 206 can include photos, drawings, or combination thereof. The text 208 can include words or phrases, in columns, paragraphs, headings, or footers. The symbol 210 can include non-ASCII characters, icons, or combination thereof.

Objects including the image 206 the text 208, or the symbol 210 can optionally be radio buttons, selectable, clickable, static, or combination thereof. The content represented by the objects, specific to preferences, selections, viewing time, or combination thereof, can preferably include links to other pages in the same other documents, web sites, web pages, pages in the same document, context, application, or ecosystem.

Selecting, clicking, or activating, the objects preferably provides navigation or access to related content in a format consistent with the format 204. The symbol 210 can also be consistent with the related content and the format 204 and can change dynamically such as dynamic symbols 210 based on the related content, selection, activation, or combination thereof. For example, different size, shape, color, configuration, or combination thereof, can distinguish the symbol 210 for playing content, the symbol 210 for getting more information, the symbols for buying a service, or the symbols for buying a product.

As an example, a topic or subject related to content of the format 204, such as “MUSIC” can include the image 206 related to a cover story subsection within the content of the format 204. A cover page of the format 204 can also identify content subsections within the content of the format 204 such as a cover story subsection, a featured album subsection, any other content, or combination thereof. The cover page may further include embedded or integrated controls for playing content such as playing a song from an album featured in the featured album subsection of the content of the format 204.

For illustrative purposes, the format 204 is shown with the objects that can selected, clicked, or activated for navigation or access to related content although it is understood that hands free activation or navigation such as contextually relevant speech controls may also be used. Similarly, a user of the content of the format 204 may designate content to be read aloud in a predefined language.

It has been discovered that the display system 100 with the format 204 utilizing the images 206 the text 208, or the symbols 210 can provide a user with a consistent interface including links to other pages in the same other documents, web sites, web pages, pages in the same document, context, application, or ecosystem. The user can easily navigate and view related content in the same document, context, application, or ecosystem without interruption or distraction.

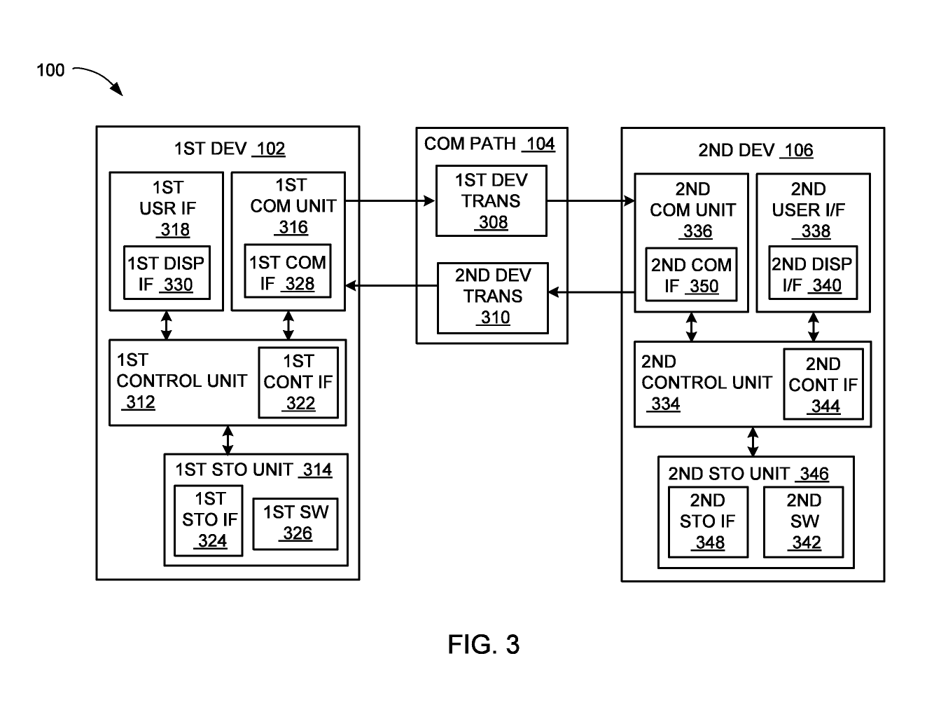

Referring now to FIG. 3, therein is shown an exemplary block diagram of the display system 100. The display system 100 can include the first device 102, the communication path 104, and the second device 106. The first device 102 can send information in a first device transmission 308 over the communication path 104 to the second device 106. The second device 106 can send information in a second device transmission 310 over the communication path 104 to the first device 102.

For illustrative purposes, the display system 100 is shown with the first device 102 as a client device, although it is understood that the display system 100 can have the first device 102 as a different type of device. For example, the first device 102 can be a server having a display interface.

Also for illustrative purposes, the display system 100 is shown with the second device 106 as a server, although it is understood that the display system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of an embodiment of the present invention.

The first device 102 can include a first control unit 312, a first storage unit 314, a first communication unit 316, and a first user interface 318. The first control unit 312 can include a first control interface 322. The first control unit 312 can execute a first software 326 to provide the intelligence of the display system 100.

The first control unit 312 can be implemented in a number of different manners. For example, the first control unit 312 can be a processor, an application specific integrated circuit (ASIC) an embedded processor, a microprocessor, a hardware control logic, a hardware finite state machine (FSM), a digital signal processor (DSP), or a combination thereof. The first control interface 322 can be used for communication between the first control unit 312 and other functional units in the first device 102. The first control interface 322 can also be used for communication that is external to the first device 102.

The first control interface 322 can receive information from the other functional units or from external sources, or can transmit information to the other functional units or to external destinations. The external sources and the external destinations refer to sources and destinations external to the first device 102.

The first control interface 322 can be implemented in different ways and can include different implementations depending on which functional units or external units are being interfaced with the first control interface 322. For example, the first control interface 322 can be implemented with a pressure sensor, an inertial sensor, a microelectromechanical system (MEMS), optical circuitry, waveguides, wireless circuitry, wireline circuitry, or a combination thereof.

The first storage unit 314 can store the first software 326. The first storage unit 314 can also store the relevant information, such as data representing incoming images, data representing previously presented image, sound files, or a combination thereof.

The first storage unit 314 can be a volatile memory, a nonvolatile memory, an internal memory, an external memory, or a combination thereof. For example, the first storage unit 314 can be a nonvolatile storage such as non-volatile random access memory (NVRAM), Flash memory, disk storage, or a volatile storage such as static random access memory (SRAM).

The first storage unit 314 can include a first storage interface 324 to provide access to the relevant information. The first storage interface 324 can be used for communication between and other functional units in the first device 102. The first storage interface 324 can also be used for communication that is external to the first device 102.

The first storage interface 324 can receive information from the other functional units or from external sources, or can transmit information to the other functional units or to external destinations. The external sources and the external destinations refer to sources and destinations external to the first device 102.

The first storage interface 324 can include different implementations depending on which functional units or external units are being interfaced with the first storage unit 314. The first storage interface 324 can be implemented with technologies and techniques similar to the implementation of the first control interface 322.

The first communication unit 316 can enable external communication to and from the first device 102. For example, the first communication unit 316 can permit the first device 102 to communicate with the second device 106 of FIG. 1, an attachment, such as a peripheral device or a computer desktop, and the communication path 104.

The first communication unit 316 can also function as a communication hub allowing the first device 102 to function as part of the communication path 104 and not limited to be an end point or terminal unit to the communication path 104. The first communication unit 316 can include active and passive components, such as microelectronics or an antenna, for interaction with the communication path 104.

The first communication unit 316 can include a first communication interface 328. The first communication interface 328 can be used for communication between the first communication unit 316 and other functional units in the first device 102. The first communication interface 328 can receive information from the other functional units or can transmit information to the other functional units.

The first communication interface 328 can include different implementations depending on which functional units are being interfaced with the first communication unit 316. The first communication interface 328 can be implemented with technologies and techniques similar to the implementation of the first control interface 322.

The first user interface 318 allows a user (not shown) to interface and interact with the first device 102. The first user interface 318 can include an input device and an output device. Examples of the input device of the first user interface 318 can include a keypad, a touchpad, soft-keys, a keyboard, a microphone, an infrared sensor for receiving remote signals, or any combination thereof to provide data and communication inputs.

The first user interface 318 can include a first display interface 330 such as the display interface 202 of FIG. 2. The first display interface 330 can include a display, a projector, a video screen, a speaker, or any combination thereof.

The first control unit 312 can operate the first user interface 318 to display information generated by the display system 100. The first control unit 312 can also execute the first software 326 for the other functions of the display system 100. The first control unit 312 can further execute the first software 326 for interaction with the communication path 104 via the first communication unit 316.

The second device 106 can be optimized for implementing an embodiment of the present invention in a multiple device embodiment with the first device 102. The second device 106 can provide the additional or higher performance processing power compared to the first device 102. The second device 106 can include a second control unit 334, a second communication unit 336, and a second user interface 338.

The second user interface 338 allows a user (not shown) to interface and interact with the second device 106. The second user interface 338 can include an input device and an output device. Examples of the input device of the second user interface 338 can include a keypad, a touchpad, soft-keys, a keyboard, a microphone, or any combination thereof to provide data and communication inputs. Examples of the output device of the second user interface 338 can include a second display interface 340 such as the display interface 202. The second display interface 340 can include a display, a projector, a video screen, a speaker, or any combination thereof.

The second control unit 334 can execute a second software 342 to provide the intelligence of the second device 106 of the display system 100. The second software 342 can operate in conjunction with the first software 326. The second control unit 334 can provide additional performance compared to the first control unit 312.

The second control unit 334 can operate the second user interface 338 to display information. The second control unit 334 can also execute the second software 342 for the other functions of the display system 100, including operating the second communication unit 336 to communicate with the first device 102 over the communication path 104.

The second control unit 334 can be implemented in a number of different manners. For example, the second control unit 334 can be a processor, an embedded processor, a microprocessor, hardware control logic, a hardware finite state machine (FSM), a digital signal processor (DSP), or a combination thereof.

The second control unit 334 can include a second controller interface 344. The second controller interface 344 can be used for communication between the second control unit 334 and other functional units in the second device 106. The second controller interface 344 can also be used for communication that is external to the second device 106.

The second controller interface 344 can receive information from the other functional units or from external sources, or can transmit information to the other functional units or to external destinations. The external sources and the external destinations refer to sources and destinations external to the second device 106.

The second controller interface 344 can be implemented in different ways and can include different implementations depending on which functional units or external units are being interfaced with the second controller interface 344. For example, the second controller interface 344 can be implemented with a pressure sensor, an inertial sensor, a microelectromechanical system (MEMS), optical circuitry, waveguides, wireless circuitry, wireline circuitry, or a combination thereof.

A second storage unit 346 can store the second software 342. The second storage unit 346 can also store the such as data representing incoming images, data representing previously presented image, sound files, or a combination thereof. The second storage unit 346 can be sized to provide the additional storage capacity to supplement the first storage unit 314.

For illustrative purposes, the second storage unit 346 is shown as a single element, although it is understood that the second storage unit 346 can be a distribution of storage elements. Also for illustrative purposes, the display system 100 is shown with the second storage unit 346 as a single hierarchy storage system, although it is understood that the display system 100 can have the second storage unit 346 in a different configuration. For example, the second storage unit 346 can be formed with different storage technologies forming a memory hierarchal system including different levels of caching, main memory, rotating media, or off-line storage.

The second storage unit 346 can be a volatile memory, a nonvolatile memory, an internal memory, an external memory, or a combination thereof. For example, the second storage unit 346 can be a nonvolatile storage such as non-volatile random access memory (NVRAM), Flash memory, disk storage, or a volatile storage such as static random access memory (SRAM).

The second storage unit 346 can include a second storage interface 348. The second storage interface 348 can be used for communication between other functional units in the second device 106. The second storage interface 348 can also be used for communication that is external to the second device 106.

The second storage interface 348 can receive information from the other functional units or from external sources, or can transmit information to the other functional units or to external destinations. The external sources and the external destinations refer to sources and destinations external to the second device 106.

The second storage interface 348 can include different implementations depending on which functional units or external units are being interfaced with the second storage unit 346. The second storage interface 348 can be implemented with technologies and techniques similar to the implementation of the second controller interface 344.

The second communication unit 336 can enable external communication to and from the second device 106. For example, the second communication unit 336 can permit the second device 106 to communicate with the first device 102 over the communication path 104.

The second communication unit 336 can also function as a communication hub allowing the second device 106 to function as part of the communication path 104 and not limited to be an end point or terminal unit to the communication path 104. The second communication unit 336 can include active and passive components, such as microelectronics or an antenna, for interaction with the communication path 104.

The second communication unit 336 can include a second communication interface 350. The second communication interface 350 can be used for communication between the second communication unit 336 and other functional units in the second device 106. The second communication interface 350 can receive information from the other functional units or can transmit information to the other functional units.

The second communication interface 350 can include different implementations depending on which functional units are being interfaced with the second communication unit 336. The second communication interface 350 can be implemented with technologies and techniques similar to the implementation of the second controller interface 344.

The first communication unit 316 can couple with the communication path 104 to send information to the second device 106 in the first device transmission 308. The second device 106 can receive information in the second communication unit 336 from the first device transmission 308 of the communication path 104.

The second communication unit 336 can couple with the communication path 104 to send information to the first device 102 in the second device transmission 310. The first device 102 can receive information in the first communication unit 316 from the second device transmission 310 of the communication path 104. The display system 100 can be executed by the first control unit 312, the second control unit 334, or a combination thereof. For illustrative purposes, the second device 106 is shown with the partition having the second user interface 338, the second storage unit 346, the second control unit 334, and the second communication unit 336, although it is understood that the second device 106 can have a different partition. For example, the second software 342 can be partitioned differently such that some or all of its function can be in the second control unit 334 and the second communication unit 336. Also, the second device 106 can include other functional units not shown in FIG. 3 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the display system 100 is described by operation of the first device 102 and the second device 106. It is understood that the first device 102 and the second device 106 can operate any of the modules and functions of the display system 100.

The modules described in this application can be part of the first software 226 of FIG. 2, the second software 242 of FIG. 2, or a combination thereof. These modules can also be stored in the first storage unit 214 of FIG. 2, the second storage unit 246 of FIG. 2, or a combination thereof. The first control unit 212, the second control unit 234, or a combination thereof can execute these modules for operating the computing system 100.

The computing system 100 has been described with module functions or order as an example. The computing system 100 can partition the modules differently or order the modules differently. The modules described in this application can be hardware implementation, hardware circuitry, or hardware accelerators in the first control unit 212 of FIG. 2 or in the second control unit 234 of FIG. 2. The modules can also be hardware implementation, hardware circuitry, or hardware accelerators within the first device 102 or the second device 106 but outside of the first control unit 212 or the second control unit 234, respectively.

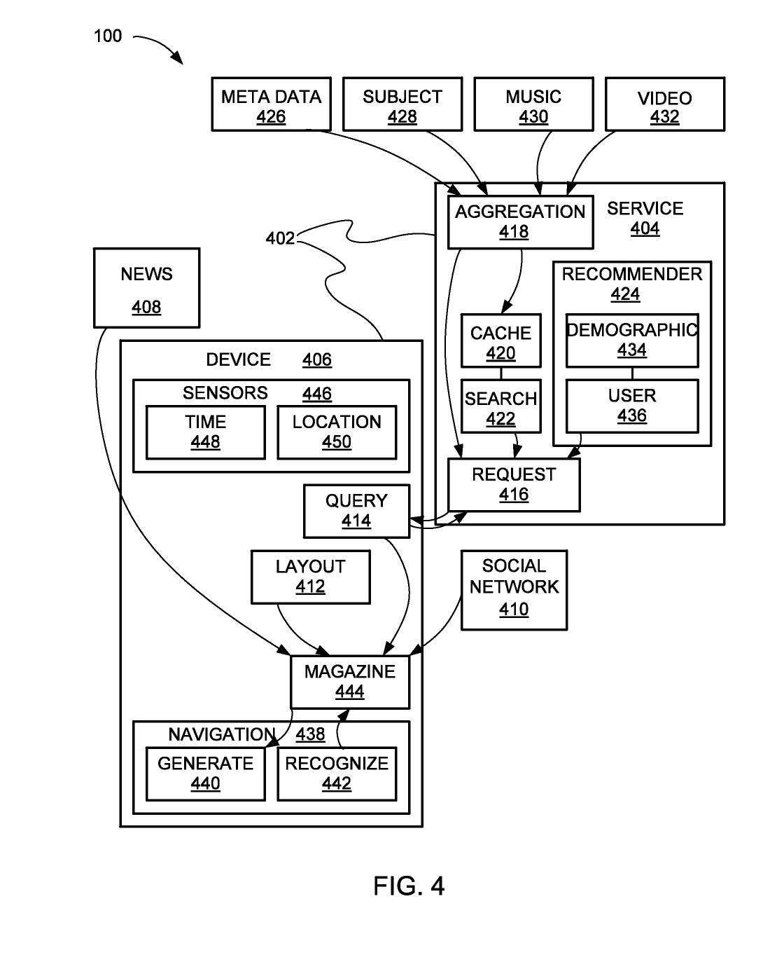

Referring now to FIG. 4, therein is shown a control flow of the display system 100 in an embodiment of the present invention. The display system 100 can present dynamic multimedia content in the format 204 such as a magazine style layout. The display system 100 can include one or more of the first device 102 of FIG. 1 or the second device of FIG. 1 such as user devices including laptops, mobile phones, or other electronic devices. Each of the user devices can include a magazine module 402, which preferably includes a magazine application, for multimedia content presentation and user discovery of content.

The magazine module 402 can include a service server module 404, a device module 406, or combination thereof. The service server module 404 of magazine module 402 can collect different types of media content including video content, electronic books, games, apps, images, news, or combination thereof from one or more content providers such as a news publisher 408, a social network 410, a magazine service server, any other content provider, or combination thereof.

For example, ticker-tape type content items such as breaking news and social feeds from content providers can be pushed to the magazine module 402. The magazine module 402 can also pull content, such as dynamically queried content, from content providers. The magazine module 402 may connect with a content provider via any type of network connection, such as a cellular, internet, other network protocols, or combination thereof.

The magazine module 402 presents the collected content in the format 204 such as a magazine style layout, a grid layout, a sectional layout, or combination thereof. The magazine module 402 models a paper magazine in terms of content presentation and user discovery of the collected content under general and variable subject areas. The magazine module 402 integrates elements of layout, structured elements, and content into a style that reflects paper magazines. Further, the magazine module 402 allows for dynamic or active browsing and navigation through the collected content.

The device module 406 of the magazine module 402 can include a layout engine module 412 and a query module 414. The query module 414 sends requests for content to the service server module 404 such as a magazine service server of the system 100. The layout engine module 412 is used to organize and format the display of media content in a magazine style layout.

The service server module 404 can include a request agent module 416, an aggregation service module 418, a content cache module 420, a content search module 422, and a recommender module 424. The service server module 404 can be implemented by any of a variety of centralized or decentralized computing devices, or video transmission devices such as the first device 102 of FIG. 1 or the second device 106 of FIG. 1.

The aggregation service module 418 receives content or data relating to different types of media content from one or more content providers, such as a metadata supplier 426, a subject-matter supplier 428, a music supplier 430, or a video supplier 432. The aggregation service module 418 collects, combines, assembles, complies, incorporates, accumulates, or aggregates the content or data received.

The content cache module 420 stores or caches content for modules such as the content search module 422, the query module 414, other modules, or combination thereof. Stored content can be based on a size or device type of the content cache module 420.

The content search module 422 can review and selectively sort contents of the content cache module 420 or other content or data. A request or selection such as a user request or user selection of content displayed in the format 204 can invoke the content search module 422.

The recommender module 424 maintains one or more demographic models 434, and one or more user models 436. Maintaining the demographic models 434 or the user models 436 can include storing, updating, verifying, comparing, or combination thereof by the recommender module 424. The user model 436 can include user preferences, user interaction history, user personal data, or combination thereof, for providing or recommending relevant content for display in the format 204. Similarly, the demographic model 434 can include information regarding user socio-economic group, user organizational affiliations, user group participation, or combination thereof, for providing or recommending relevant content for display in the format 204.

The request agent module 416 receives content requests from the first device 102 of FIG. 1 or the second device 106 of FIG. 1 such as user devices. The request agent module 416 sends content to the user devices in response to a content request received from the user device. The request agent module 416 receives and sends content for each content request based on content or data from one or more of the following: the aggregation service module 418, the content search module 422, the recommender module 424, or combination thereof.

The device module 406 of the magazine module 402 further includes a voice navigation module 438 that provides speech generation functionality in a speech generation module 440 and speech recognition functionality in a speech recognition module 442. Each of the magazine modules 402 can also provide contextually relevant speech controls via the voice navigation module 438.

A user of the magazine module 402 can designate content to be read aloud in a predefined language. A user may also navigate the magazine using only voice such as without touch. In an embodiment, speech navigation can be activated automatically when the user is in a hands-free situation. For example, the user who is driving may navigate through a playlist presented by the magazine using speech navigation.

The news publisher 408, the social network 410, the layout engine module 412, and the speech recognition module 442 can preferably provide input such as content, data, requests, commands, or combination thereof, to the magazine format module 444. The magazine format module 444 can provide output such as content, data, requests, commands, or combination thereof, to the speech generation module 440 based on the received input.

Each of the user devices can also include one or more sensor modules 446, such as a time sensor module 448 and a location sensor module 450. The time sensor module 448 can record elapsed time or clock time for any of the modules or content for any of the modules. The time sensor module 448 can also provide adjustment or compensation of elapsed or clock time. Similarly, the location sensor module 450 can record source location or destination location for any of the modules or content for any of the modules. The location sensor module 450 can also provide adjustment or compensation of source location or destination location.

Navigation through the magazine format 204 can preferably be dynamic. Navigation or access of the format 204 generates and presents active content throughout each page of the format 204. The presentation of the active content can be determined dynamically by subject, topic, context, learned user behavior, or combination thereof. The magazine application may use the sensor modules 446 to determine context such as time, location, other sensor input, or combination thereof. The content of the format 204 can be dynamically created based on both content, content type, and content structure to update the format 204 of the display interface 202.

In an embodiment, tapping on a content item that links to or comprehends more content will trigger dynamic creation of additional content to update the format 204 of the display interface 202. For example, in a bluegrass-themed music magazine, tapping on a diagonal page banner headline associated with an upcoming concert for a banjo musician may generate custom magazine content of the format 204 associated with the time and place of the concert and the musician. Content is collected and generated in the structure of the format 204 such as a concert playbill, covering aspects of the concert venue, the musician's biography and background, background information relating to the art form such as bluegrass music, transportation to and from the concert venue, and a general guide to other acts also performing at the same time and place.

Magazine structure and content of the format 204 can be created dynamically based on a request to update the format 204 of the display interface 202. The request can be contextual and incorporate user requests such as a search with the content search module 422 or an input device click on a name, as well as social, spatial, and temporal context such as a user with a spouse and near a café, so the user receives format 204 with content about cafés within the user's proximity.

Content of the format 204 may be customized to any device such as small television screens, large television screens, projections, or other display devices, including layout and appropriate content in particular visual content. Content of the format 204 can also provide customized content based on personalized machine learning for external content from multiple external sources. Content of the format 204 can provide time-sensitive content such as game scores, flash news, or events within the format 204.

The magazine module 402 or magazine application can provide customized magazine structure or content of the format 204 that is learned from a user's behavior such as results or reading or interacting with the format 204. The service server module 404 can learn the user's behavior, as well as aggregated behaviors of groups of similar users based on predetermined criteria such as behaviors, preferences, or other user criteria.

When the magazine module 402 or the magazine application collects content, the magazine application can retrieve content from a magazine service server of the service server module 404. The magazine application can also retrieve content from, link to, or reference content on, other content providers such as web sites or network-based services such as wireless fidelity (Wi-Fi) services. Both the magazine service server and the magazine application can track user behavior.

The display system 100 has been described with module functions or order as an example. The display system 100 can partition the modules differently or order the modules differently. For example, the content search module 422 does not require content from the content cache module 420 for executing a search of content. Although, the content search module 422 can search the content stored with the content cache module 420.

The modules described in this application can be hardware implementation or hardware accelerators in the first control unit 316 of FIG. 3 or in the second control unit 338 of FIG. 3. The modules can also be hardware implementation or hardware accelerators within the first device 102 or the second device 106 but outside of the first control unit 316 or the second control unit 338, respectively.

The physical transformation from content or data results in the movement in the physical world, such as displayed content or data and user interaction therewith. Movement in the physical world results in changes or updates to the displayed content or data of the format 204 of the display interface 202 based on received input from the physical world.

It has been discovered that the display system 100 with the magazine module 402 including the service server module 404 or the device module 406 provides a “Live Magazine”. The “magazine” is a self-contained ecosystem and is “live” because the contents such as the image 206, the text 208, the symbol 210 such as actionable symbols 210 and actionable icons 210, or combination thereof can change. The actionable contents, symbols 210, or icons 210, are rendered based on content type, context, learning, time sensitivity, and other factors, creating new decision paths.

It has also been discovered that the magazine module 402 including the service server module 404 or the device module 40 provides an “ecosystem” where a user does not leave the application or system for navigating or accessing content.

It has further been discovered that the magazine module 402 including the service server module 404 or the device module 406 provides navigation or access to new content based on at least what is selected or where the navigation takes a user. The display system 100 provides this new content dynamically to update the format 204 of the display interface 202.

It has yet further been discovered that the magazine module 402 including the service server module 404 or the device module 406 provides dynamic symbols 210 or “action icons”. The symbols 210 or “action icons” change based on the type of content, for example playing content, getting more information, or buying a product or service.

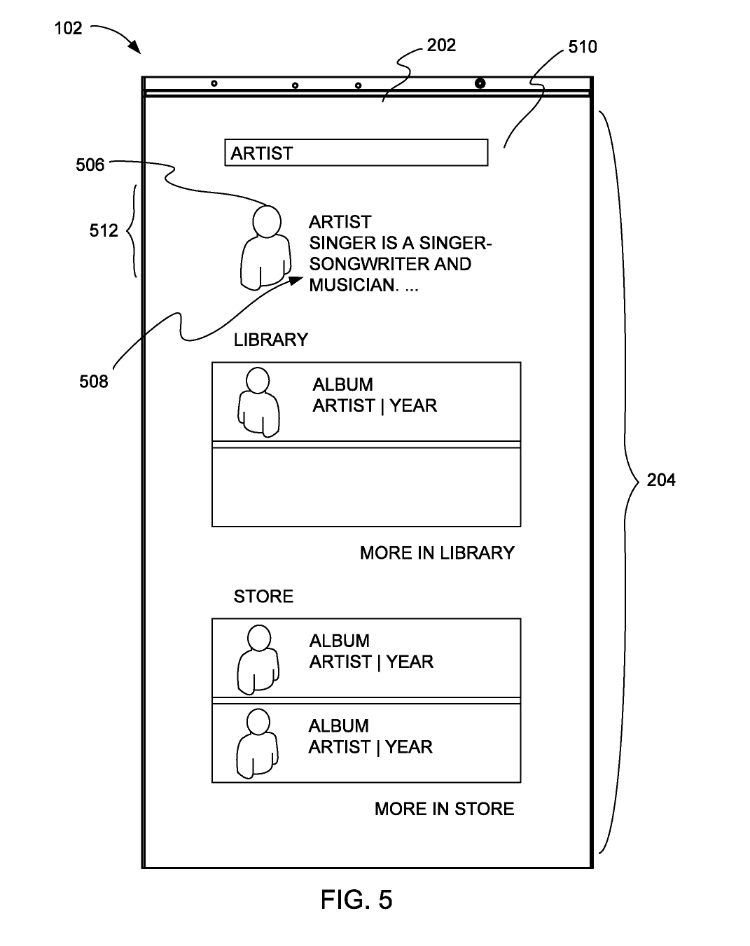

Referring now to FIG. 5, therein is shown an example of the display interface 202 of the first device 102 in an embodiment of the present invention. Similarly, the second device 106 of FIG. 1 may also include a display interface such as the display interface 202. The display interface 202 can display a format 204 including an image 506, a text 508, a symbol 510, or combination thereof. The format 504 preferably includes the text 508, associated with the image 506, overlapped or wrapped with the text 508.

The image 506, the text 508, or the symbol 510 can represent content specific to preferences, selections, viewing time, or combination thereof. The image 506 can include photos, drawings, or combination thereof. The text 508 can include words or phrases, in columns, paragraphs, headings, or footers. The symbol 510 can include non-ASCII characters, icons, or combination thereof.

The display interface 202 displays search results 512 of a search functionality provided within magazines generated by a magazine application such as the content search module 422 of the magazine module 402. A magazine may include an embedded or integrated search engine, such as the content search module 422, that a user may utilize to search for content.

The magazine may search both a local library including content of the user device, such as the first device 102 of FIG. 1, and the magazine service server including network content, such as the service server module 404 of FIG. 4, for search results. Each of the search results 512 can be displayed as a magazine page or section of the magazine page. For example, search results for “Adele” include an artist magazine relating to Adele, and album magazines relating to Adele's albums preferably based on predetermined preferences.

It has been discovered that the magazine module 402 with the content search module 422 generates search results from local content or network content. The search results can be displayed or arranged based on predetermined preferences.

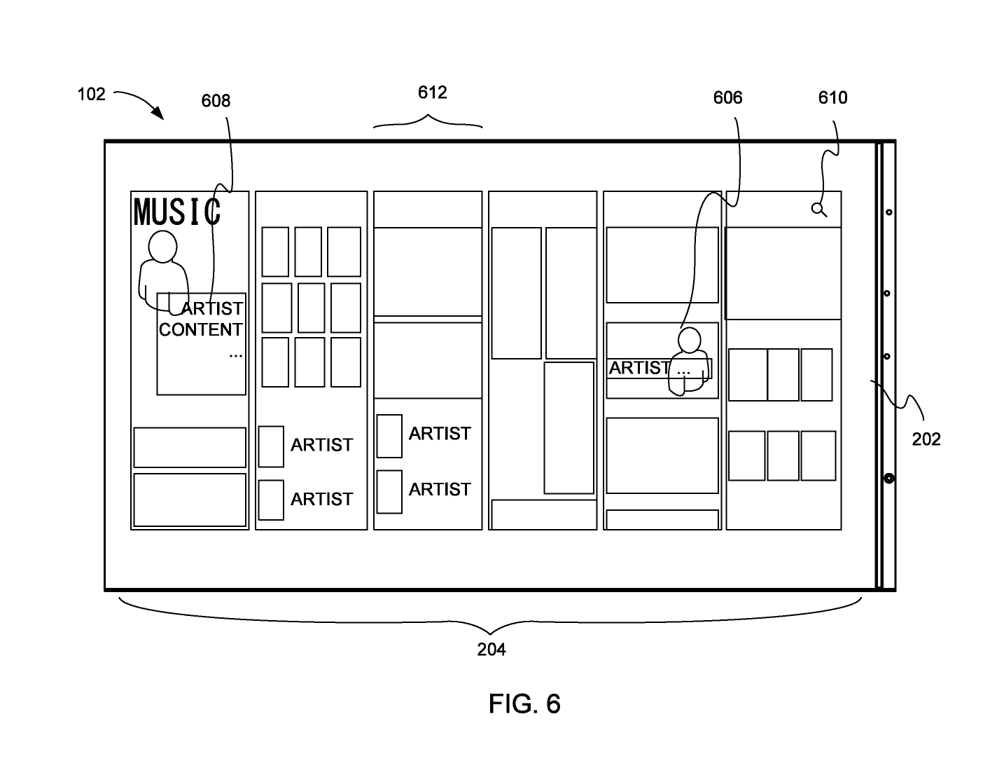

Referring now to FIG. 6, therein is shown an example of the display interface 202 of the first device 102 in an embodiment of the present invention. Similarly, the second device 106 of FIG. 1 may also include a display interface such as the display interface 202. The display interface 202 can display a format 204 including an image 606, a text 608, a symbol 610, or combination thereof. The format 604 preferably includes the text 608, associated with the image 606, overlapped or wrapped with the text 608.

The image 606, the text 608, or the symbol 610 can represent content specific to preferences, selections, viewing time, or combination thereof. The image 606 can include photos, drawings, or combination thereof. The text 608 can include words or phrases, in columns, paragraphs, headings, or footers. The symbol 610 can include non-ASCII characters, icons, or combination thereof.

The format 204 can include a display with multiple pages or panels 612 preferably in a column format in a manner similar to a magazine. The panels 612 can be denoted by a separator 612 such as spacing, shadowing, coloring, drawn line, or combination thereof. The panels 612 can also shows multiple magazines such as the panels 612. A magazine may generate magazines in a recursive manner. There may be multiple layers of magazines within a magazine ecosystem. A user may thumb or page through the panels or contents of a magazine.

For example, a music-related magazine or “music magazines” may link to one or more artist-related magazines or “artist magazines” and one or more album-related magazines or “album magazines” that are dynamically generated by the music-related magazine. An album magazine may link to one or more artist-related magazines and other album-related magazines. A magazine generated by the magazine module 402 or the magazine application replaces the need to access a separate music store application, a separate music player application, or combination thereof. Multiple user actions such as searching, browsing, purchasing, or combination thereof can be performed “in-place” or within the format 504 of the magazine ecosystem.

For another example, a magazine may have one or more inserts. A music magazine may have embedded booklets or magazines about artists, bands, venues, events, or albums. The magazine module 402 can enable a user to search, browse, discover content, engage with people or groups, conduct transactions and perform other user actions in-place or within the magazine ecosystem. The format 504 of the magazine module 402 provides both static and dynamic content such as active content. The magazine module 402 or the magazine application can dynamically create magazines as a user thumbs or pages through the contents or panels 612 in the format 504 of the magazine ecosystem.

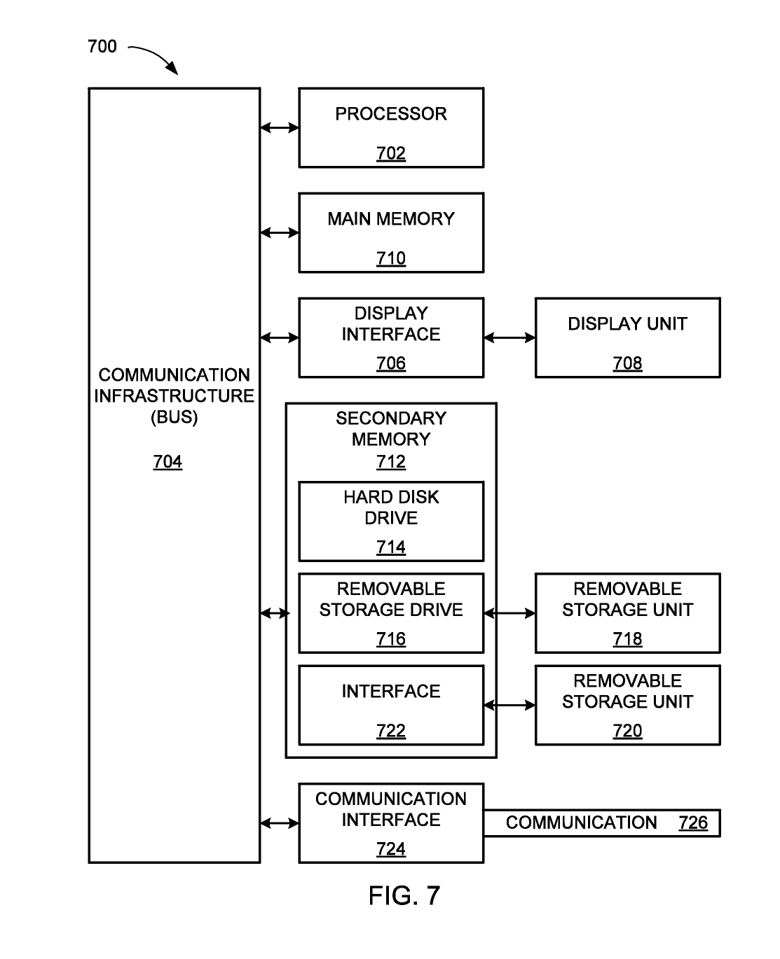

Referring now to FIG. 7, therein is shown an exemplary block diagram of a display system 700 in an embodiment of the present invention. The display system 700 can provide information processing system useful for implementing one embodiment of the present invention. A computer system such as the first device 102 of FIG. 1 or the second device of FIG. 1 can include one or more processors, such as processor 702. The processor 702 can be connected to a communication infrastructure 704 such as a communications bus, cross-over bar, or network.

The computer system can include a display interface 706 that forwards graphics, text, and other data from the communication infrastructure 704 or from a frame buffer (not shown) for display on a display unit 708. The computer system also includes a main memory 710, preferably random access memory (RAM), and may also include a secondary memory 712. The secondary memory 712 may include, for example, a hard disk drive 714, a removable storage drive 716, or combination thereof, representing for example a floppy disk drive, a magnetic tape drive, or an optical disk drive.

The removable storage drive 716 communicates with, such as reads from, writes to, or combination thereof, a removable storage unit 718. The removable storage unit 718 represents, for example, a floppy disk, a compact disc, a magnetic tape, an optical disk, other storage devices, or combination thereof, which is read by and written to the removable storage drive 716. As will be appreciated, the removable storage unit 718 includes a computer readable medium having stored therein computer software, data, or combination thereof.

In alternative embodiments, the secondary memory 712 may include other similar means for allowing computer programs or other instructions to be loaded into the computer system. Such means may include, for example, a removable storage unit 720 and an interface 722. Examples of such means may include a program package and package interface (such as that found in video game devices), a removable memory chip (such as an EPROM, or PROM) and associated socket, and other removable storage units 720 and interfaces 722 which allow software and data to be transferred from the removable storage unit 720 to the computer system.

The computer system may also include a communication interface 724. Communication interface 724 allows software and data to be transferred between the computer system and external devices. Examples of communication interface 724 may include a modem, a network interface (such as an Ethernet card), a communication port, or a PCMCIA slot and card, etc. Software and data transferred via communication interface 724 are in the form of signals which may be, for example, electronic, electromagnetic, optical, or other signals capable of being received by communication interface 724. These signals are provided to communication interface 724 via a communication path 726 or channel. This communication path 726 carries signals and may be implemented using wire or cable, fiber optics, a phone line, a cellular phone link, an RF link, and/or other communication channels.

In this document, the terms “computer program medium,” “computer usable medium,” and “computer readable medium” are used to generally refer to media such as main memory 710 and secondary memory 712, removable storage drive 716, and a hard disk installed in hard disk drive 714.

Computer programs also called computer control logic are stored in main memory 710 and/or secondary memory 712. Computer programs may also be received via communication interface 724. Such computer programs, when run, enable the computer system to perform the features of the present invention as discussed herein. In particular, the computer programs, when run, enable the processor 702 to perform the features of the computer system. Accordingly, such computer programs represent controllers of the computer system.

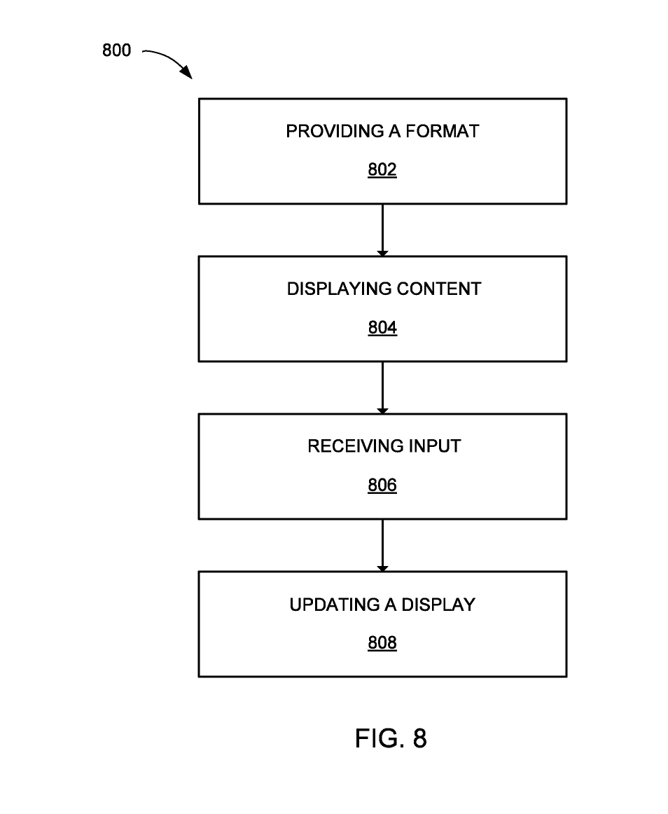

Referring now to FIG. 8, therein is shown a flow chart of a method 800 of operation of a display system 100 in an embodiment of the present invention. The method 800 includes: providing a format in a block 802; displaying content with the format configured to display on a display interface in a block 804; receiving input based on the content displayed with the format on the display interface in a block 806; and receiving input based on the content displayed with the format on the display interface in a block 808.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A display system comprising:
a storage unit configured to provide access to a format;
a display interface, coupled to the storage unit, configured to provide a display of content with the format;
a communication unit, coupled to the display interface, configured to receive input based on the display; and
a control unit, coupled to the communication unit, configured to update a second display of a second content with the format based on the input and configured to display on the display interface.

2. The system as claimed in claim 1 wherein the display interface is configured to provide the second display of the second content with the format.

3. The system as claimed in claim 1 wherein the control unit is configured to update the second display of the second content with text.

4. The system as claimed in claim 1 wherein the control unit is configured to update the second display of the second content with a symbol.

5. The system as claimed in claim 1 wherein the control unit is configured to update the second display of the second content with a link to a third content.

6. The system as claimed in claim 1 wherein the storage unit is configured to provide access to a magazine format.

7. The system as claimed in claim 6 further comprising a content search module, coupled to the communication unit, configured to sort other content based on the input.

8. The system as claimed in claim 6 further comprising a recommender module, coupled to the storage unit, configured to maintain a user model configured to provide a display of content with the format.

9. The system as claimed in claim 6 further comprising a recommender module configured to maintain a demographic model configured to provide a display of content with the format.

10. The system as claimed in claim 6 wherein the communication unit is configured to receive a selection from a user.

11. A method of operation of a display system comprising
providing a format;
displaying content with the format configured to display on a display interface;
receiving an input based on the content displayed with the format on the display interface; and
updating a second display of a second content with the format based on the input and configured to display on the display interface.

12. The method as claimed in claim 11 further comprising displaying the second display of the second content with the format on the display interface.

13. The method as claimed in claim 11 wherein updating the second display of the second content includes updating with text.

14. The method as claimed in claim 11 wherein updating the second display of the second content includes updating with a symbol.

15. The method as claimed in claim 11 wherein updating the second display of the second content includes updating with a link to a third content.

16. The method as claimed in claim 11 wherein providing the format includes providing a magazine format.

17. The method as claimed in claim 16 further comprising sorting other content based on the input.

18. The method as claimed in claim 16 wherein displaying content with the format includes displaying content based on a user model.

19. The method as claimed in claim 16 wherein displaying content with the format includes displaying content based on a demographic model.

20. The method as claimed in claim 16 wherein receiving an input includes receiving a selection from a user.
